(19) United States
(12) Patent Application Publication
(10) Pub. No.: US 2026/0366485 A1
(43) Pub. Date: Nov. 19, 2026

(54) WIND TURBINE BLADE MANUFACTURE

(71) Applicant: VESTAS WIND SYSTEMS A/S, Aarhus N (DK)

(72) Inventors: Mie REHMEIER, Sabro (DK); Troels Bach NIELSEN, Risskov (DK)

(21) Appl. No.: 19/138,582

(22) PCT Filed: Dec. 13, 2023
(86) PCT No.: PCT/DK2023/050306

§ 371 Date: Jun. 12, 2025

(30) Foreign Application Priority Data
Dec. 13, 2022 (DK) PA202270601

(51) Int. Cl. F03D 1/06; B29B 17/02; B29L 31/08

(52) U.S. Cl. CPC F03D 1/0679; B29B 17/0206; B29B 2017/0293; B29L 2031/085; F05B 2280/6003

(57) ABSTRACT

A wind turbine blade is disclosed. The wind turbine blade comprises a core material, a first fibre reinforced plastic and a spar cap comprising a third fibre reinforced plastic, and a shear web comprising a second fibre reinforced plastic. The first fibre reinforced plastic, the second fibre reinforced plastic, and the spar cap each comprise a chemically disassemblable polymer. Further disclosed is a method of disassembling such a wind turbine blade by exposing the wind turbine blade to an acid to cause the chemically disassemblable polymer to disassemble; and recovering fibres from at least of one of the first fibre reinforced plastic, the second fibre reinforced plastics and the third fibre reinforced plastic.

### TECHNICAL FIELD The present invention relates generally to wind turbine blades and methods for recycling wind turbine blades.

### BACKGROUND

Composite wind turbine blades comprise a number of components which are variously configured to resist the loads and conditions experienced by the blade during extended use under extreme conditions while restricted by space, weight and shape to provide an aerodynamically efficient shape. Use of composite materials in the manufacture of such components is typically advantageous because the arrangement of materials used can be optimised to a high degree according to the specific requirements of each component. However, this can result in blades having a complex bill of materials including several types of fibre reinforcement plastic, foam core materials and resin systems, with limited overall recycling strategy since each component may require different treatments for comprehensive recycling at end of life.

Furthermore, the nature of composite wind turbine blade construction is such that components and materials cannot be easily mechanically or chemically separated once the binding resins and adhesives are cured. As a result, it is difficult to extract materials for recycling from a blade that has reached its end of life.

It is against this background that the invention has been devised.

### SUMMARY OF THE INVENTION

A first aspect of the present invention provides a wind turbine as disclosed in claim 1. The wind turbine blade comprises a blade shell comprising a core material, a first fibre reinforced plastic and a spar cap comprising a third fibre reinforced plastic, and a shear web comprising a second fibre reinforced plastic. The first fibre reinforced plastic, the second fibre reinforced plastic, and the third fibre reinforced plastic each comprise a chemically disassemblable polymer. The shear web is for example connected to the blade shell by adhesive or by the infusion resin during the infusion of resin to form the first fibre reinforced plastic. It was found this is highly advantageous as it allows for chemically disassemble of several components of the wind turbine blade at the same time and/or under same conditions without the need to first separate the components from each other. Further, this allows for easier separation of the components not containing a chemically disassemblable polymer from the components with a chemically disassemblable polymer by first chemically disassemble the polymer or polymers, which are chemically disassemblable, and thereafter separate components not containing chemically disassemblable polymer from the disassembled components. Further, some components comprising chemically disassemblable polymer also contains elements that are not chemically disassemblable polymer, such as for example fibres, sensors, metal parts, and these may also easily be removed after chemically disassembling the chemically disassemblable polymer. By chemically disassemblable polymer is herein meant a thermoset polymer that is disassemblable in acid by chemical breaking of bonds in polymer backbone. Chemically disassemblable polymers may for example be polymers with cleavable cross-linker such as exemplified in WO2018/050189A1. Other examples of dissolvable polymers are polymers bases on the resin system marketed by Aditya Birla Group under the trademark Recyclamine® and the Elium® polymeric system from Arkema.

Optionally, the chemically disassemblable polymer of each of the first fibre reinforced plastic, the second fibre reinforced plastic, and the third fibre reinforced plastic is based on the same polymeric system. This allows for a simple process, where a large fraction of the wind turbine blade may be treated at the same time instead of careful separation of the blade into individual components prior to recycling involving chemically disassembling of the blade.

Till now, recycling of wind turbine blades has focused on recycling of fibre reinforced plastic components and mainly to extract the fibres for reuse. In some embodiments of the present invention, the blade is designed so both fibre reinforced plastic components and polymeric components without reusable fibre reinforcement (such as adhesive, coatings and/or foams) may be recycled using one general strategy, which allows for much higher efficiency in the recycling process and potentially simultaneously chemically disassembling several components of the blade. This saves time and improves overall recycling rates as for example waste from separating the components prior to individual recycling of each component may be avoided.

The wind turbine blade may comprise an adhesive. The adhesive may for example be used for adhering a shear web to the blade shell, to adhere a sensor to the blade, to adhere a blade root to the blade, and/or to adhere a leading edge protection shell to the blade. The adhesive may comprise a chemically disassemblable polymer. The chemically disassemblable polymer of the adhesive is preferably based on the same polymeric system as the chemically disassemblable polymer of each of the first fibre reinforced plastic, the second fibre reinforced plastic, and the third fibre reinforced plastic. In another embodiment, the adhesive is based on another polymeric system than polymer of the chemically disassemblable polymer of at least the first fibre reinforced plastic and the second fibre reinforced plastic.

In an embodiment, the wind turbine blade further comprises at least one wind turbine blade coating arranged on the blade shell, wherein the blade coating also comprises a chemically disassemblable polymer. Preferably the chemically disassemblable polymer of the wind turbine blade coating is based on the same polymeric system as the chemically disassemblable polymer of each of the first fibre reinforced plastic, the second fibre reinforced plastic, and the third fibre reinforced plastic. It was found that this may allow for a system where the coating may be chemically dissolved with other components and hence not delay or prevent chemically disassemble of other parts of the blade. Furthermore, this increases the overall amount of recycle material of the blade.

The core may be a light dimensionally stable material such as for example balsa wood core or a polymer foam core. In an embodiment, the core is a thermoplastic foam core material and preferably a material of a non-chemically disassemblable polymeric system. The foam core may therefore be easily separated from the components comprising chemically disassemblable polymer after these components have been partially or fully chemically disassembled. This would also be the case if the core for example is based on balsa wood. In another embodiment, the core material is a foam core and comprises a chemically disassemblable polymer and preferably the chemically disassemblable polymer of the foam core material is based on the same polymeric system as the chemically disassemblable polymer of each of the first fibre reinforced plastic, the second fibre reinforced plastic, and the third fibre reinforced plastic. In this embodiment, the foam core may be chemically disassembled together with the other components comprising the chemically disassemblable polymer and hence mechanically separation of the components prior to the chemically disassembling is not required.

The wind turbine blade may comprise a putty also known as a filler for adjusting aerodynamic profile and fill gaps of the wind turbine blade. The putty may comprise a chemically disassemblable polymer and preferably the chemically disassemblable polymer of the putty is based on the same polymeric system as the chemically disassemblable polymer of each of the first fibre reinforced plastic, the second fibre reinforced plastic, and the third fibre reinforced plastic. In this embodiment, the putty may be chemically disassembled together with the other components comprising the chemically disassemblable polymer and hence mechanically separation of the components prior to the chemically disassembling is not required.

In an embodiment, the properties of the first component are different from properties of the second component, where the first component and the second component are different components selected from the group consisting of the first fibre reinforced plastic, the second fibre reinforced plastic, and the third fibre reinforced plastic. If one or more of the adhesive, the coating, and the core comprises a chemically disassemblable polymer, then it is preferred that the group also contains the chemically disassemblable polymer containing components of this list. It is preferred that the properties that are different are at least two properties selected from the group of tensile strength, compression strength, bending strength, hardness, Young's modulus, transparency, abrasion resistance, surface gloss and density. For example, for the first fibre reinforced plastic and the second fibre reinforced plastic, it is preferred that the chemically disassemblable polymer is transparent to allow for visual quality assurance of wetting and/or presence of pores in the cured fibre reinforced plastic, contrary to the adhesive, which preferably are non-transparent and more preferably dyed in a bright colour (such as green, blue, red or yellow) to facilitate visual inspection of presence of adhesive in critical positions. For core material, it is preferred that the density is much lower than for other components and typically the density of the core material is less than 50% of other components. For the coating, it is preferred that the abrasion resistance as measured in an accelerated rain erosion test is higher than for other components and/or that the surface gloss is higher than for other components.

In an embodiment, the properties of the chemically disassemblable polymer of a first component are different from properties of the chemically disassemblable polymer of a second component, where the first component and the second component are different components selected from the group consisting of the first fibre reinforced plastic, the second fibre reinforced plastic, and the third fibre reinforced plastic. If one or more of the coating, the core and the adhesive comprises a chemically disassemblable polymer, then it is preferred that the group also contains the chemically disassemblable polymer containing components of this list. It is preferred that the properties that are different are at least two properties selected from the group of glass transition temperature, tensile strength, compression strength, bending strength, hardness, Young's modulus, transparency and density. In general, glass transition temperature is preferably above 70 °C, but for coatings it is preferably higher, such as above 80 °C or above 90 °C. For the first fibre reinforced plastic and the second fibre reinforced plastic, it is preferred that the chemically disassemblable polymer is transparent to allow for visual quality assurance of wetting and lack of pores in the cured fibre reinforced plastic, contrary to the adhesive, which preferably are non-transparent and more preferably dyed in a bright colour (such as green, blue, red or yellow) to facilitate visual inspection of presence of adhesive in critical positions. For core material, it is preferred that the compression strength and the shear strength of the chemically disassemblable polymer is higher than for another component.

In another embodiment, the properties of the uncured chemically disassemblable polymer resin of a first component are different from properties of the uncured chemically disassemblable polymer of a second component, where the first component and the second component are different components selected from the group consisting of the first fibre reinforced plastic, the second fibre reinforced plastic, and the third fibre reinforced plastic. If one or more of the coating, the core and the adhesive comprises a chemically disassemblable polymer, then it is preferred that the group also contains the chemically disassemblable polymer containing components of this list. It is preferred that the properties that are different are at least two properties selected from the group of transparency, colour, viscosity, pot life and cure time. For the uncured chemically disassemblable polymer resin of the first fibre reinforced plastic and the second fibre reinforced plastic, it is preferred to have a high pot life and low viscosity to allow for full infusion prior to curing of the resin. The adhesive is preferably non-transparent and more preferably dyed in a bright colour (such as green, blue, red or yellow) to facilitate visual inspection of presence of adhesive in critical positions prior to curing of the resin. If present, the chemically disassemblable polymer resin of the foam material preferably has a high ability to hold gas bubbles (e.g. a high viscosity and surface energy), a low cure time and low cure temperature. If present, the chemically disassemblable polymer resin in the spar and/or spar cap may preferably be provided via pultrusion of glass or carbon fibers, where fast curing is preferable to allow for fast processing speed.

In another embodiment, the chemically disassemblable polymer of each of the first fibre reinforced plastic, the second fibre reinforced plastic, the third fibre reinforced plastic, and the foam core material is chemically disassemblable under the same process conditions. Process conditions may for example be one or more of temperature, time, pressure, fluid in which the process is conducted, concentration of species in the fluid, presence of active ingredients such as catalysts in the fluid. This allows for the chemically disassemblable polymers of these components to be chemically disassembled at the same time whereafter other parts of these components, such as for example fibres, metal inserts, sensors and other polymer parts, may be separated easily after or during the chemical disassembling process.

In another embodiment, the chemically disassemblable polymer of the first component and the chemically disassemblable polymer of the second component are chemically disassemblable under a first set of process conditions, where the chemical disassembly of the first component under the first set of process conditions is faster than the chemical disassembly of the second component under the first set of process conditions. This allows for a sequential disassemble of the wind turbine blade. For example, the second component may comprise carbon fibres, whereas the first component may comprise glass fibres, so the stepwise chemical disassembling of the polymer allows for separation of the glass fibres before full chemical disassembling of the component comprising carbon fibres is conducted, whereby two separate fractions of fibres-one solely or primarily containing glass fibres and one solely or primarily containing carbon fibres-may be prepared. Such separated fractions allow for reuse in higher value applications than a fraction containing high amounts of both glass and carbon fibres.

In another embodiment, the chemically disassemblable polymer of the first component is chemically disassemblable under a first set of process conditions, and the chemically disassemblable polymer of the second component does not chemical disassembly under the first set of process conditions. For example, the first component, is chemically disassemble under process conditions where a catalyst is not required, for example under elevated temperature, pressure and/or under mildly acidic conditions whereas the second component may require presence of a catalyst, such as for example an organo-metal complex, more acidic conditions, and/or presence of an extra organic co-solvent, for the chemical disassemble process to take place. This allows for sequential disassembly with separation steps between the disassemble steps.

Optionally the wind turbine blade further comprises a leading edge protector arranged on at least a part of the leading edge of the blade, wherein at least a part of the leading edge protector and/or a leading edge adhesive adhering the leading edge protector to the blade comprises a chemically disassemblable polymer.

Optionally, each of the disassemblable polymers are optionally decomposable under the same process conditions.

A second aspect of the present invention provides a method according to claim 11 of disassembling a wind turbine blade.

The second aspect of the present invention provides a method of disassembling a wind turbine blade. The method comprises the steps of exposing the wind turbine blade to an acid to cause the chemically disassemblable polymer to disassemble and recovering fibres from at least one the first fibre reinforced plastic, the second fibre reinforced plastics and the third fibre reinforced plastic. Preferably, the acid comprises formic acid, as it was found that formic acid provides a relatively fast chemical disassembling and/or chemical disassembling within a practical timeframe at a lower temperature than most other acids. Furthermore, formic acid is a readily available bulk chemical which may be sourced from recyclable sources and has limited chemical risk profile. The method enables recycling of both recovered fibres and of the disassembled polymer for example in the manufacturing of new wind turbine blades or other products. This reduces the amount of virgin resources required for the manufacturing and the carbon footprint of wind turbine blades.

In an embodiment, the acid causes the chemically disassemblable polymer to disassemble into at least one monomer and/or oligomer and/or cleave the polymer backbone, and the method further comprises recovering the monomer and/or oligomer and/or polymer fraction for example by treating the chemically disassembled polymer with a base. The recovered monomers may be reused in new products, such as resin for wind turbine blades. The oligomers may be reused in new resin or further decomposed into monomers before reuse for example in new resin.

In an embodiment, the method comprises recovering non-fibrous material from the wind turbine blade, wherein optionally the non-fibrous material comprises metal, wood, non-disassembled polymer and/or partially disassembled polymer. Non-disassembled polymer may for example be thermoplastic based core material or components of non-disassemblable thermoset resin, such as a coating or a thermoset composite material.

In one embodiment, the wind turbine blade is divided into pieces before exposure to the acid. This was found to facilitate handling of the pieces and may involve removing components that are not affected by the chemical disassembling process and hence would only increase volume of the treated piece without gaining from the process.

In one embodiment, the method further comprises removing the spar cap before exposure to the acid. It was found that in some cases, even if the spar is susceptible to chemical disassembling, mechanical separation of these components prior to chemical disassembling may allow for better separation of (carbon) fibres of the spar cap from the (glass) fibres of the first fibre reinforced plastic and/or the second fibre reinforced plastic.

In one embodiment, the properties of the chemically disassemblable polymer of a first component are different from properties of the chemically disassemblable polymer of a second component, where the first component and the second component are different components selected from the group consisting of the first fibre reinforced plastic, the second fibre reinforced plastic, and the third fibre reinforced plastic. If one or more of the coating, the core, and the adhesive comprises a chemically disassemblable polymer, then it is preferred that the group also contains the chemically disassemblable polymer containing components of this list. It is preferred that the properties that are different are at least two properties selected from the group of glass transition temperature, tensile strength, compression strength, bending strength, hardness, Young's modulus, transparency and density. The chemically disassemblable polymer of the first component and the chemically disassemblable polymer of the second component are chemically disassemblable under a first set of process conditions, where the chemical disassembly of the first component under the first set of process conditions is faster than the chemical disassembly of the second component under the first set of process conditions. In this embodiment, exposing the wind turbine blade to the acid to cause the chemically disassemblable polymer to disassemble comprises the steps of first at least partially chemically disassemble the first component and the second component under the first set of process conditions, and thereafter separating the second component from the first component, and thereafter disassemble the second component under a second set of process conditions. This process may be taken into account already during manufacturing of the wind turbine blade and allows for chemically disassembling enhanced separation by blade design, yielding simple processing and recycled products of higher value.

In one embodiment, the properties of the chemically disassemblable polymer of a first component are different from properties of the chemically disassemblable polymer of a second component, where the first component and the second component are different components selected from the group consisting of the first fibre reinforced plastic, the second fibre reinforced plastic, and the third fibre reinforced plastic. If one or more of the coating, the core, and the adhesive comprises a chemically disassemblable polymer, then it is preferred that the group also contains the chemically disassemblable polymer containing components of this list.

It is preferred that the properties that are different are at least two properties selected from the group of glass transition temperature, tensile strength, compression strength, bending strength, hardness, Young's modulus, transparency and density. The chemically disassemblable polymer of the first component is chemically disassemblable under a first set of process conditions, and the chemically disassemblable polymer of the second component does not chemical disassembly under the first set of process conditions. In this embodiment, exposing the wind turbine blade to the acid to cause the chemically disassemblable polymer to disassemble comprises the steps of first at least partially chemically disassemble the first component under the first set of process conditions, thereafter separating the second component from the first component, and thereafter disassemble the second component under a second set of process conditions. This process may be taken into account already during manufacturing of the wind turbine blade and allows for chemically disassembling enhanced separation by blade design, yielding simple processing and recycled products of higher value.

In another aspect, the present invention provides a wind turbine comprising a plurality of wind turbine blades as described above mounted on a hub, wherein the hub is mounted on a nacelle which is supported by a tower.

In a further aspect, the present invention provides a method of making a wind turbine blade comprising: arranging a core material, first fibres and a spar cap of third fibre reinforced plastic in a blade mould and infusing the first fibres with a resin, preparing a shear web from second fibres and a resin to form second fibre reinforced plastic, assembling blade shells and the shear web using an adhesive, wherein the first fibre reinforced plastic, the second fibre reinforced plastic, and the third fibre reinforced plastic comprise a chemically disassemblable polymer. Alternatively, the blade may be prepared by a one shot process where whole blade shells is infused at the same time and one or more shear webs are placed inside the blade shell before or after the infusion.

Optionally the method comprises the step of using fibres recovered from a wind turbine blade in another method of this invention as first fibres and/or second fibres.

Optionally, the method comprises the step of using a core material recovered from a wind turbine blade in another method of this invention as core material.

### BRIEF DESCRIPTION OF THE DRAWINGS

So that it may be more fully understood, the invention will now be described, by way of example only, with reference to the following drawings, in which like features are assigned like reference numerals, and in which:

FIG. 1 is a schematic perspective view of a wind turbine blade;

FIG. 2 is a schematic cross-sectional view of a wind turbine blade;

FIG. 3 shows a typical horizontal axis wind turbine; and

FIG. 4 shows a method of disassembling a wind turbine blade.

### DETAILED DESCRIPTION

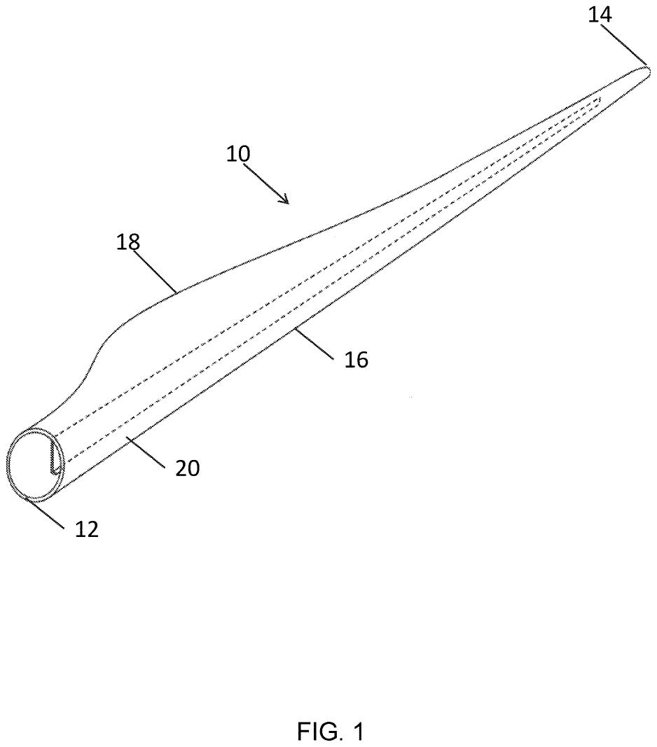

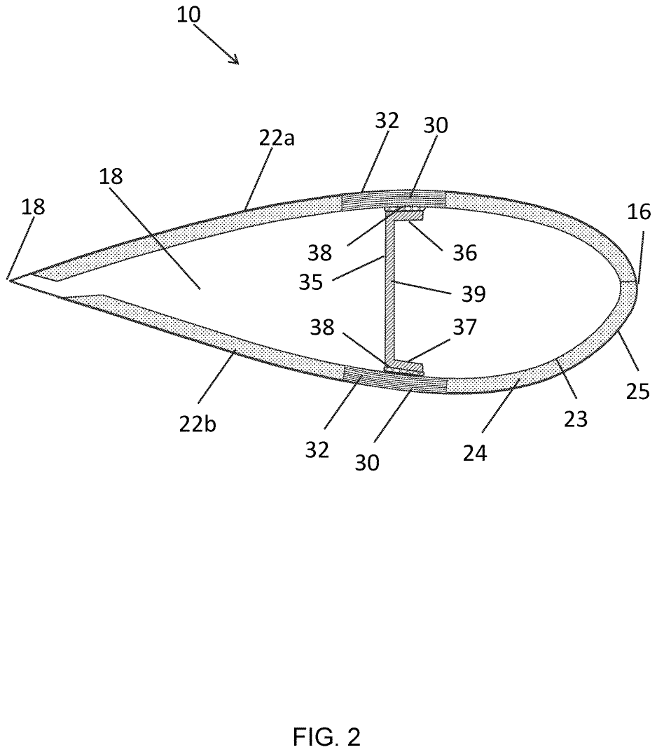

To provide context for the invention, FIGS. 1 and 2 show the structure of an example wind turbine blade. FIG. 1 is a schematic perspective view of a wind turbine blade 10 and FIG. 2 is a schematic cross-sectional view of the wind turbine blade 10. As seen in FIG. 1, the blade 10 extends in a spanwise direction between a root end 12 and a tip end 14, and in a chordwise direction between a leading edge 16 and a trailing edge 18.

The blade 10 comprises an aerodynamic outer shell 20 defining a substantially hollow interior 21 therewithin. The outer shell 20 may be formed of a first half shell 22a, and a second half shell 22b joined together at or near the leading and trailing edges 16, 18 with a polymer-based adhesive (not shown).

The outer shell 20 is a composite construction comprising a core material, such as a polymer-based foam core material 24 arranged between inner 23 and outer 25 first fibre reinforced plastic (FRP) skins in a sandwich structure. The inner and outer skins 23, 24 comprise layers of fibrous material such as, for example, carbon fibre, glass fibre and aramid fibre provided in non-crimp fabrics, chopped strand mats or woven fabrics. The outer shell 20 further comprises a polymer matrix material which binds the arrangement of core material 24 and fibrous material together to form an integrated structure.

The outer shell 20 may be reinforced to take up loads experienced by the blade 10 in use and to improve the structural rigidity of the blade. In the example shown in FIG. 2, the first half shell 22a and the second half shell 22b each comprise longitudinally extending reinforcing structures known as spar caps 30. The spar caps 30 typically comprise third fibre reinforced plastic 32 comprising layers of third fibre reinforcing material held in laminated form by a polymer matrix material. In the example of FIG. 2 the spar caps 30 are embedded within the outer shell 20. However, in other examples they may be joined to the inner skins 23 of the shell 20 using a polymer-based adhesive, such as a further adhesive 38.

The outer shell 20 may optionally comprise a leading edge protector (not shown) attached to the leading edge 16 of the blade 10 to protect the leading edge 16 of the blade 10 in use. The leading edge protector may comprise another FRP material comprising layers of fibrous reinforcing material held in laminated form by a polymer matrix material. Alternatively, the leading edge protector may comprise only polymer-based material or a coating. The leading edge protector may be adhered to the blade using a leading edge adhesive.

The outer shell 20 may also comprise a coating applied to its outer skin 24 for the purpose of protecting the shell structure 20 from exposure to environmental conditions when the blade 10 is in use. The coating may be a polymer-based gelcoat or paint.

As seen in FIGS. 1 and 2, the blade 10 also comprises a shear web 35 that extends longitudinally in the spanwise direction inside the outer shell 20; i.e. inside the hollow interior 21 of the blade 10. In some examples, the wind turbine blade 10 may comprise a plurality of shear webs 35, such as a trailing edge shear web and a main shear web. Each shear web 35 forms part of a spar structure which is configured to absorb bending and torsional loading of the blade 10 in use. As shown in FIG. 2, an upper web flange 36 of the shear web 35 is connected to the inner skin 23 of the first half shell 22a, and a lower web flange 37 is connected to the inner skin 23 of the second half shell 22b. The shear web 35 is bonded to the shell 20 by a polymer-based further adhesive 38 located between the upper and lower web flanges 36, 37 and the respective inner skins 23 of the shell 20. The shear web 35 comprises a second fibre reinforced plastic material 39 comprising layers of second fibre reinforcing material held in laminated form by a polymer matrix material.

Several of the components making up the blade 10 comprises one or more polymer-based materials in the form of a matrix material, a coating, an adhesive, or a foam. The polymer-based materials may be thermoset or thermoplastic materials, but for wind turbine blades the polymer-based materials are typically thermosetting materials.

In the example shown here, each of the polymer-based materials used to manufacture the blade 10 are configured to be chemically disassemblable by exposure to an acid such as acetic acid or formic acid. For example, each polymer-based material may be configured to disassemble into monomers and/or oligomers and/or cleave the polymer backbone upon exposure to acetic acid at a concentration of between 20% to 50% in water. In this way, the polymer-based material or materials may be disassembled by any combination of softening, swelling, disintegration and/or dissolution, thereby allowing the fibrous reinforcing material to be released from the various components making up the blade 10 and recovered for recycling. Recently developed epoxy resin systems which are configured to chemically disassemble under certain process conditions may be used to form the various polymer-based components of the wind turbine blade 10 described above. Examples include, but are not limited to, the Recyclamine® polymeric system from Aditya Birla Group, and the Elium® polymeric system from Arkema.

The polymeric system(s) which form the various polymer-based materials of the blade 10 are preferably selected to minimise the number different disassembly steps required. This may be achieved by forming the various polymer-based components of the blade 10 from different polymeric systems which are disassemblable under the same or similar process conditions. However, preferably all of the polymer-based materials forming the blade 10 are based on the same polymeric system so that one set of process conditions may be used to disassemble the polymer-based materials of the blade 10 to allow recovery and recycling of the fibre reinforcing materials and also the polymer material itself (depending on the polymeric system).

In alternative examples, the various polymer-based components forming the blade 10 may be based on two or more different polymeric systems which each require a specific set of process conditions in order to chemically disassemble. For example, the polymer-based further adhesive 38, and any other polymer-based adhesives used to form the blade 10 (such as the adhesive joining the first shell half 22a to the second shell half 22b), may be based on a first polymeric system requiring a first set of disassembly process conditions, while some or all of the other polymer-based components of the blade 10 are based on a second polymeric system requiring a second set of disassembly process conditions. The first set of process conditions may cause disassembly of the of the polymer-based materials based on the first polymeric system at a faster rate than the second set of process conditions cause chemical disassembly of the polymer-based materials that are based on the second polymer system. Alternatively, the two sets of process conditions may cause disassembly of the polymer-based materials at the same rate.

In the example above, the bonded components of the blade may first be separated by subjecting the blade to the first set of process conditions, and, once separated, the remaining blade components may be treated under the second set of process conditions. This approach may also be useful, for example, to allow the fibrous material of the outer shell 20 to be released and recovered separately from the fibrous material of the shear web 35. This is advantageously mitigating the need for a secondary fibre sorting process where the fibre composition of the outer shell 20 is different from that of the shear web 35.

The polymer-based materials which are based on the second polymeric system may be largely unaffected by the first set of process conditions, or disassembly of these polymer-based may begin during exposure to the first set of process conditions. For example, the polymer-based materials which are based on the second polymeric system may soften during exposure to the first set of process conditions. This may be beneficial, for example, to allow the components which are made from the second polymeric system to be split up into smaller pieces for faster processing during exposure to the second set of process conditions.

It will be understood that the above discussion provides examples only and that any number of polymeric systems, with any number of sets of disassembly process condition requirements, may be used to make the various components of the blade 10.

In all the examples discussed above, the temperature of the acid solution may be elevated to accelerate the rate of chemical disassembly. For example, the acid solution may be at a temperature of between 60 °C and 90 °C.

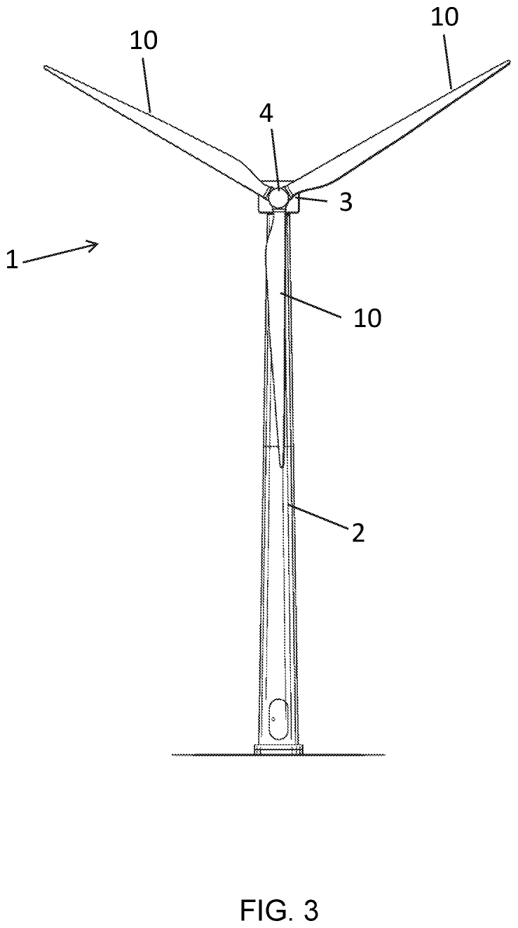

FIG. 3 shows a wind turbine 1 comprising a plurality of wind turbine blades 10. The wind turbine 1 shown in FIG. 3 is a representation of a typical horizontal axis wind turbine (HAWT) that includes a tower 2, a nacelle 3 mounted at the apex of the tower 2, and a rotor hub 4 supported on the nacelle 3. Three wind turbine blades 10 are supported by the rotor hub 4.

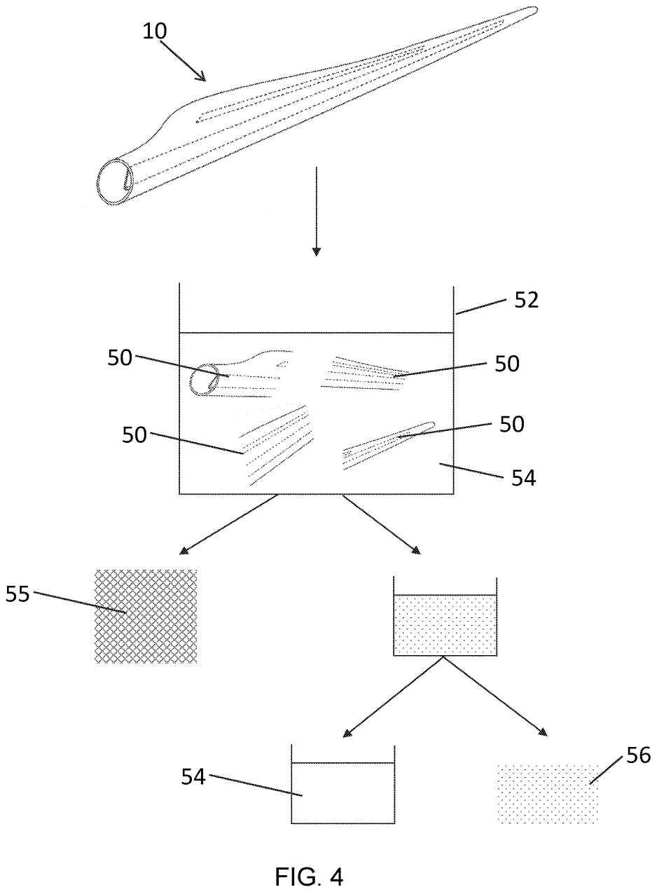

Turning now to FIG. 4, a method of disassembling a wind turbine blade 10 which is configured as described above is shown. In this example, all the polymer-based components of the blade 10 are based on the same polymeric system.

In a first step, the blade 10 is mechanically divided into smaller blade portions 50 by sawing or crushing, for example. The blade portions 50 are then exposed to acid solution 42 such as submersing or spraying the blade portions 50 with a water-based solution with a concentration of for example 40% acetic acid in water. The acid solution 42 is heated to a temperature of 85 °C before the blade portions 50 are submerged in the solution 42 and the temperature of 85 °C is maintained for the duration of the disassembly treatment process. Other temperatures are also feasible and is a compromise between evaporation, heating and process time.

Exposure of the blade portions 50 to the acid solution 54 causes chemical disassembly of the polymer-based material(s) thereby converting the chemically disassemblable polymers of the blade 10 into monomers and/or oligomers and/or polymer fractions while leaving the fibrous reinforcing materials and other not chemically disassemblable components of the outer shell, the spar caps and the shear web intact. The chemical disassembly of the polymer structures causes the polymer-based materials to soften, swell, disintegrate and/or dissolve in the acid, thereby releasing the fibrous reinforcing materials and other non-disassemblable elements. A typical process time for the treatment of a blade 10 to allow release of the fibrous reinforcing materials is 10 minutes to several days or even weeks depending on the process conditions and the polymeric system in question. Once the polymer-based materials are sufficiently disassembled, the fibre reinforcement is recovered from the bath 52 by filtering the mixture of acetic acid and disassembled polymer material, for example. The fibre reinforcement may then be cleaned and reused as a recycled dry fibre material 55. In one example, the dry fibre material 55 may be shredded and used in the production of chopped strand mats of randomly oriented chopped fibres. If the FRP materials comprise a plurality of fibre types, then an additional fibre sorting step may be required if a stepwise dissolving has not been used.

After the fibre reinforcement 55 is removed from the bath 52, the disassembled polymer material 56 may be extracted from the acid solution 54 using an appropriate separation technique. The recovered disassembled polymer material 57 may be recycled using known techniques and the remaining acetic acid 54 may be reused in the disassembly of further wind turbine blades.

Any metallic or other non-polymeric materials (such as wood) may also be recovered from the bath 52. In an alternative example, any mechanically removeable metal (or other material) parts may be removed from the blade 10 before the blade 10 is exposed to the acid solution 54. In a further alternative example, the spar, spar cap 30 and or shear web 35 may be removed from the blade 10 before the blade shell 20 is exposed to the acid solution 54.

The skilled person will appreciate that modifications may be made to the specific embodiments described above without departing from the inventive concept as defined by the claims.

1. A wind turbine blade comprising:
a blade shell comprising a core material, a first fibre reinforced plastic and a spar cap comprising a third fibre reinforced plastic,
and a shear web comprising a second fibre reinforced plastic,
wherein the first fibre reinforced plastic, the second fibre reinforced plastic, and the spar cap each comprise a chemically disassemblable polymer.

2. The wind turbine blade of claim 1, wherein the chemically disassemblable polymer of each of the first fibre reinforced plastic, the second fibre reinforced plastic, and the third fibre reinforced plastic is based on the same polymeric system.

3. The wind turbine blade of claim 1, further comprising an adhesive, which adhesive comprises a chemically disassemblable polymer, preferably the chemically disassemblable polymer of the adhesive is based on the same polymeric system as the chemically disassemblable polymer of each of the first fibre reinforced plastic, the second fibre reinforced plastic, and the third fibre reinforced plastic.

4. The wind turbine blade of claim 1, further comprising at least one wind turbine blade coating arranged on the blade shell, wherein the blade coating comprises a chemically disassemblable polymer, preferably the chemically disassemblable polymer of the wind turbine blade coating is based on the same polymeric system as the chemically disassemblable polymer of each of the first fibre reinforced plastic, the second fibre reinforced plastic, and the third fibre reinforced plastic.

5. The wind turbine blade of claim 1, wherein the core material is a foam core and comprising a chemically disassemblable polymer, preferably the chemically disassemblable polymer of the foam core material is based on the same polymeric system as the chemically disassemblable polymer of each of the first fibre reinforced plastic, the second fibre reinforced plastic, and the third fibre reinforced plastic.

6. The wind turbine blade of claim 1, wherein properties of a first component are different from properties of a second component, where the first component and the second component are different components selected from the group consisting of the first fibre reinforced plastic, the second fibre reinforced plastic, and the third fibre reinforced plastic.

7. The wind turbine blade of claim 1, wherein properties of the chemically disassemblable polymer of a first component are different from properties of the chemically disassemblable polymer of a second component, where the first component and the second component are different components selected from the group consisting of the first fibre reinforced plastic, the second fibre reinforced plastic, and the third fibre reinforced plastic.

8. The wind turbine blade of claim 1, wherein the chemically disassemblable polymer of each of the first fibre reinforced plastic, the second fibre reinforced plastic, the third fibre reinforced plastic, and the foam core material is chemically disassemblable under the same process conditions.

9. The wind turbine blade of claim 6, wherein the chemically disassemblable polymer of the first component and the chemically disassemblable polymer of the second component are chemically disassemblable under a first set of process conditions, where the chemical disassembly of the first component under the first set of process conditions is faster than the chemical disassembly of the second component under the first set of process conditions.

10. The wind turbine blade of claim 6, wherein the chemically disassemblable polymer of the first component is chemically disassemblable under a first set of process conditions, and the chemically disassemblable polymer of the second component does not chemical disassembly under the first set of process conditions.

11. A method of disassembling a wind turbine blade, wherein the wind turbine blade comprises:
a blade shell comprising a core material, a first fibre reinforced plastic and a spar cap comprising a third fibre reinforced plastic; and
a shear web comprising a second fibre reinforced plastic;
wherein the first fibre reinforced plastic, the second fibre reinforced plastic, and the spar cap each comprise a chemically disassemblable polymer;
wherein the method, comprises:
exposing the wind turbine blade to an acid to cause the chemically disassemblable polymer to disassemble; preferably the acid comprises formic acid, and
recovering fibres from at least of one of the first fibre reinforced plastic, the second fibre reinforced plastics and the third fibre reinforced plastic.

12. The method of claim 11, wherein the acid causes the chemically disassemblable polymer to disassemble into at least one monomer and/or oligomer and/or polymer fraction, the method further comprising recovering the monomer and/or oligomer.

13. The method of claim 11, further comprising recovering non-fibrous material from the wind turbine blade, wherein optionally the non-fibrous material comprises metal, wood, non-disassembled polymer and/or partially disassembled polymer.

14. The method of any one of claims 11, further comprising dividing the wind turbine blade into pieces before exposure to the acid.

15. The method of any one of claims 11, further comprising removing the spar or spar cap before exposure to the acid.

16. The method of any one of the claims 11, wherein the properties of the chemically disassemblable polymer of a first component are different from properties of the chemically disassemblable polymer of a second component, where the first component and the second component are different components selected from the group consisting of the first fibre reinforced plastic, the second fibre reinforced plastic, and the third fibre reinforced plastic, and
the chemically disassemblable polymer of the first component and the chemically disassemblable polymer of the second component are chemically disassemblable under a first set of process conditions, where the chemical disassembly of the first component under the first set of process conditions is faster than the chemical disassembly of the second component under the first set of process conditions, and
exposing the wind turbine blade to the acid to cause the chemically disassemblable polymer to disassemble comprises the steps of first at least partially chemically disassemble the first component and the second component under the first set of process conditions, thereafter separating the second component from the first component, and thereafter disassemble the second component under a second set of process conditions.

17. The method of any one of the claims 11, wherein the properties of the chemically disassemblable polymer of a first component are different from properties of the chemically disassemblable polymer of a second component, where the first component and the second component are different components selected from the group consisting of the first fibre reinforced plastic, the second fibre reinforced plastic, and the third fibre reinforced plastic, and
the chemically disassemblable polymer of the first component is chemically disassemblable under a first set of process conditions, and the chemically disassemblable polymer of the second component does not chemical disassembly under the first set of process conditions, and
exposing the wind turbine blade to the acid to cause the chemically disassemblable polymer to disassemble comprises the steps of first at least partially chemically disassemble the first component under the first set of process conditions, thereafter separating the second component from the first component, and thereafter disassemble the second component under a second set of process conditions.
